(19) United States
(12) Patent Application Publication
(10) Pub. No.: US 2024/0284543 A1
(43) Pub. Date: Aug. 22, 2024

(54) METHOD AND APPARATUS FOR PROXIMITY SERVICES IN A TELECOMMUNICATION NETWORK

(71) Applicant: Samsung Electronics Co., Ltd., Suwon-si, Gyeonggi-do (KR)

(72) Inventors: Mahmoud WATFA, Staines, Middlesex (GB); Mehrdad SHARIAT, Staines, Middlesex (GB)

(21) Appl. No.: 18/290,004

(22) PCT Filed: May 11, 2022
(86) PCT No.: PCT/KR2022/006745

§ 371 Date: Nov. 8, 2023

(30) Foreign Application Priority Data
May 11, 2021 (GB) 2106676.6
May 10, 2022 (GB) 2206813.4

(51) Int. Cl. H04W 76/27; H04W 76/23; H04W 92/18

(52) U.S. Cl. CPC H04W 76/27; H04W 76/23; H04W 92/18

(57) ABSTRACT

The disclosure relates to a 5G or 6G communication system for supporting a higher data transmission rate. Disclosed is a method of operating a User Equipment, UE, operable to communicate with a telecommunication network, wherein if the UE is in 5GMM-CONNECTED mode with RRC inactive indication and the UE wishes to use PC5 resources for communication, then the UE requests a transition to RRC_CONNECTED state.

### TECHNICAL FIELD

The disclosure relates to Proximity Services (ProSe) in a telecommunication network. It relates particularly, but not exclusively to a Fifth Generation (5G) network, also known as 5GS.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Proximity Services for 5GS is specified in TS 23.304. ProSe allows for direct discovery and communication between User Equipments, UEs, using so called “PC5 resources” where these resources do not require other resources in the core network, CN.

The UE in idle mode may transition to connected mode to perform PC5 discovery and/or communication.

How the UE transitions to connected mode may vary based on a trigger for a service request procedure at a non-access stratum, NAS, layer. In some cases, the UE would need to first go to 5GMM-IDLE mode and re-establish the connection, while in other cases the UE requests the RRC to resume its connection. In the latter case, the NAS may or may not send a message after the resumption of the RRC connection which again is determined based on the reason to resume the connection.

The UE in 5GMM-CONNECTED mode may receive a fallback indication from the RRC layer after which the UE re-establishes the NAS signaling connection.

Depending on a particular type of procedure that may be pending before the fallback indication is received by NAS, the recovery method of NAS signaling connection (i.e. re-establishment of the NAS connection) may vary.

### DISCLOSURE OF INVENTION

### Technical Problem

The prior art situation poses at least two problems. Firstly, there is no means by which the UE can transition to 5GMM-CONNECTED mode from 5GMM-CONNECTED mode with RRC inactive indication when the UE needs to perform PC5 discovery and/or communication.

Previously, it is described how the UE in 5GMM-IDLE mode can transition to 5GMM-CONNECTED mode when the UE needs to use PC5 resources for discovery and/or communication. However, there is an additional mode that is not discussed which is 5GMM-CONNECTED mode with RRC inactive indication. When in this mode, the UE's RRC connection is considered to be idle (i.e. not connected) and so if the UE wants to use PC5 resources for discovery and/or communication, then there is currently no specified means to do so.

For example, one UE may first change its mode before sending a NAS message, whereas a second UE may send a NAS message from the current mode, etc. However, the different behaviours can lead to unpredictability in the system, and this goes against the specification in which detailed conditions are required for every specific case. Also, since no behaviour is defined, then another UE may not act in any way and so remain in a state of no service.

Also, for the current means to transition to connected mode from idle mode, with the Service Request message, in order to perform PC5 discovery and/or communication, the prior art does not describe how the UE sets the Service type IE.

Secondly, hot to achieve recovery from a lower layer fallback indication for the purpose of PC5 discovery and/or communication is not specified in the prior art.

The NAS specification, TS 24.501, describes how the UE recovers its NAS connection after a fallback indication is received, wherein the recovery method depends on the procedure that may be pending at the time when the fallback indication is received. For example, one UE may recover with a NAS registration procedure, where another UE may recover with a service request procedure. However, since no behaviour is currently defined, then another UE may not act in any way and so remain in a state of no service.

The prior art does not consider the case when the UE receives a fallback indication for a UE that was engaged in PC5 discovery and/or communication at the time when the fallback is received. This poses a problem as, otherwise, the UE behaviour may be unpredictable i.e. different UEs may recover using different methods. A standardized and predictable method is preferred for this in order to ensure consistent UE behaviour.

It is aim of embodiments of the disclosure to address these and other shortcomings in the prior art, whether mentioned herein or not.

### Solution to Problem

According to the disclosure there is provided an apparatus and method as set forth in the appended claims. Other features of the disclosure will be apparent from the dependent claims, and the description which follows.

According to a first aspect of the disclosure, there is provided a method of operating a User Equipment, UE, operable to communicate with a telecommunication network, wherein if the UE is in 5GMM-CONNECTED mode with RRC inactive indication and the UE wishes to use PC5 resources for communication, then the UE requests a transition to RRC_CONNECTED state.

In an embodiment, the PC5 resources are for one or more of: 5G ProSe direct discovery over PC5; 5G ProSe direct communication over PC5; and V2X communication over PC5.

In an embodiment, the request for transition to RRC_CONNECTED state is made to a lower layer

According to a second aspect of the disclosure, there is provided a UE operable to perform the method of the first aspect.

According to a third aspect of the disclosure, there is provided a method of operating a User Equipment, UE, operable to communicate with a telecommunication network, wherein the UE, if in 5GMM-CONNECTED mode, receives a fallback indication and the UE has no ongoing NAS procedure and no pending uplink user data for a Protocol Data Unit, PDU, session, and the UE, at the time of receiving the fallback indication, was using network resources for 5G ProSe direct discovery, 5G ProSe direct communication or V2X communication over PC5, then the UE enters 5GMM-IDLE mode and initiates a service request procedure to recover the NAS connection.

In an embodiment, while recovering the NAS connection, the UE includes an Uplink data stats Information Element, IE, in a Service Request message or Control Plane Service Request message, indicating the PDU session for which User Plane, UP, resources were active prior to receipt of the fallback indication.

According to a fourth aspect of the disclosure, there is provided UE operable to perform the method of the third aspect.

In an aspect, provision is made to enable a transition from 5GMM-CONNECTED mode with RRC inactive indication to 5GMM-CONNECTED mode for the purpose of PC5 discovery and/or communication.

In another aspect, provision is made for re-establishing a NAS connection after fallback indication for a UE that was performing PC5 discovery and/or communication.

Although a few preferred embodiments of the disclosure have been shown and described, it will be appreciated by those skilled in the art that various changes and modifications might be made without departing from the scope of the disclosure, as defined in the appended claims.

### BRIEF DESCRIPTION OF DRAWINGS

For a better understanding of the disclosure, and to show how embodiments of the same may be carried into effect, reference will now be made, by way of example only, to the accompanying diagrammatic drawings in which:

FIG. 1 shows a UE in communication with a network, according to an embodiment of the disclosure;

FIG. 2 shows a flowchart according to a first embodiment of the disclosure;

FIG. 3 shows a flowchart according to a second embodiment of the disclosure; and

FIG. 4 shows a block diagram illustrating a structure of a user equipment according to an embodiment of the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

Proximity Services for 5GS is specified in TS 23.304. ProSe allows for direct discovery and communication between User Equipments, UEs, using so called “PC5 resources” where these resources do not require other resources in the core network, CN.

The UE in idle mode would need to transition to connected mode to perform PC5 discovery and/or communication. The following is specified in TS 23.304:

### ″6.7.3 Service Request Procedure

The Service Request procedures for UE in CM-IDLE state are performed as defined in TS 23.502 clause 4.2.3.2 and clause 4.2.3.3 with the following additions:
If the UE is authorised to use ProSe services, then the AMF may include “ProSe authorised” information in the NGAP message, indicating which of the ProSe services the UE is authorised to use as described in clause 16.7.2.

The AMF includes the ProSe NR UE-PC5-AMBR in the NGAP message to the NG-RAN as part of the UE context and NG-RAN may use in resource management of UE's PC5 transmission for ProSe services in network scheduled mode.
The AMF sends the PC5 QoS parameters for ProSe to NG-RAN via N2 signalling. The PC5 QoS parameters for ProSe may be stored in the UE context after the registration procedure. If the UE is authorised to use ProSe services but AMF does not have PC5 QOS parameters for ProSe available, the AMF fetches the PC5 QoS parameters for ProSe from the PCF.”

Following on from the above, a new trigger for the service request procedure was agreed as shown below:
“the UE has to request resources for ProSe direct discovery over PC5 or ProSe direct communication over PC5.”

Note that the same method is also used for V2X communication over PC5 and so the following trigger for the service request is defined in TS 24.501:
“1) the UE in 5GMM-IDLE mode over 3GPP access has to request resources for V2X communication over PC5 (c.g., 3GPP TS 23.287).”

Moreover, when the UE sends the Service Request for V2X communication over PC5, the UE:
Sets the Service type IE in the SERVICE REQUEST message to “high priority access”, if the UE is configured as high priority access, or
Otherwise, sets the Service type IE in the SERVICE REQUEST message to “signalling” except, if there is an emergency PDU session which is indicated in the Uplink data status IE, the service type IE in the SERVICE REQUEST message may be set to “emergency services”

The UE can also be in another mode, which is 5GMM-CONNECTED mode with RRC inactive indication. The Non-Access Stratum, NAS, specification TS 24.501 describes how the UE can transition to 5GMM-CONNECTED mode, from 5GMM-CONNECTED mode with RRC inactive indication, based on the trigger to enter 5GMM-CONNECTED mode.

The following is described in section 5.3.1.5 of TS 24.501 about 5GMM-CONNECTED mode with RRC inactive indication and how the UE transitions to different modes based on different triggers.

“This subclause is only applicable for UE's 5GMM mode over 3GPP access. The 5GMM-CONNECTED mode with RRC inactive indication is not supported when the UE is in NB-N1 mode.

The UE is in 5GMM-CONNECTED mode with RRC inactive indication when the UE is in:
a) 5GMM-CONNECTED mode over 3GPP access at the NAS layer; and
b) RRC_INACTIVE state at the AS layer (c.g., 3GPP TS 38.300).

Unless stated otherwise, the UE behaviour in 5GMM-CONNECTED mode with RRC inactive indication follows the UE behaviour in 5GMM-CONNECTED over 3GPP access, except that:
a) the UE may apply the mobility restrictions; and
b) the UE may perform the PLMN selection procedures
   as in 5GMM-IDLE mode over 3GPP access.

The UE may transition from 5GMM-CONNECTED mode over 3GPP access to 5GMM-CONNECTED mode with RRC inactive indication upon receiving an indication from the lower layers that the RRC connection has been suspended.

NOTE 0: Any pending procedure or uplink data packet when receiving an indication from the lower layers that the RRC connection has been suspended, triggers a request to the lower layers to transition to RRC_CONNECTED state. This is also the case when the pending procedure or uplink data packet triggered a previous request to the lower layers to transition to RRC_CONNECTED state.

### Upon:

a) a trigger of a procedure which requires sending of a NAS message different from a REGISTRATION REQUEST message with the NG-RAN-RCU bit of the 5GS update type IE set to “UE radio capability update needed”; or
b) an uplink user data packet to be sent for a PDU session with suspended user-plane resources;
the UE in 5GMM-CONNECTED mode with RRC inactive indication over 3GPP access may request the lower layers to transition to RRC_CONNECTED state (e.g., 3GPP TS 38.300).

Upon a trigger to send a REGISTRATION REQUEST message with the NG-RAN-RCU bit of the 5GS update type IE set to “UE radio capability update needed”, the UE in 5GMM-CONNECTED mode with RRC inactive indication may move to 5GMM-IDLE mode over 3GPP access and proceed with the registration procedure for mobility and periodic registration as specified in subclause 5.5.1.3.2.

The UE may transition from 5GMM-CONNECTED mode with RRC inactive indication to 5GMM-CONNECTED mode over 3GPP access upon receiving an indication from the lower layers that the UE has transitioned to RRC_CONNECTED state (c.g., 3GPP TS 38.300).

NOTE 1: The AMF can be aware of the transition between 5GMM-CONNECTED mode and 5GMM-CONNECTED mode with RRC inactive indication for a UE (e.g., 3GPP TS 23.502).

The UE may trigger a transition from 5GMM-CONNECTED mode with RRC inactive indication to 5GMM-IDLE mode upon selection of a PLMN that is not an equivalent PLMN to the registered PLMN. The UE may not trigger a transition from 5GMM-CONNECTED mode with RRC inactive indication to 5GMM-IDLE mode upon entering a new PLMN which is in the list of equivalent PLMNs.

The UE may trigger a transition from 5GMM-CONNECTED mode with RRC inactive indication to 5GMM-IDLE mode upon receiving REFRESH command from the UICC as specified in subclause 5.4.5.3.3.

If the UE in 5GMM-CONNECTED mode with RRC inactive indication receives an indication from the lower layers that the RRC connection has been suspended, the UE may stay in 5GMM-CONNECTED mode with RRC inactive indication. The UE may re-initiate any pending procedure that had triggered the request to the lower layers to transition to RRC_CONNECTED state, if still needed.

When the UE in 5GMM-CONNECTED mode with RRC inactive indication receives a fallback indication from lower layers, and the UE has no pending NAS procedure and no pending uplink user data for PDU session(s) with user-plane resources already established, the UE may:
a) enter 5GMM-IDLE mode; and
b) initiate the registration procedure for mobility and periodic registration update and include the Uplink data status IE in the REGISTRATION REQUEST message indicating the PDU session(s) for which user-plane resources were active prior to receiving the fallback indication, if any (see subclause 5.5.1.3 for further details).

If the UE requests the lower layers to transition to RRC_CONNECTED state at initiation of a registration procedure, a service request procedure or a de-registration procedure, upon fallback indication from lower layers, the UE may:
enter 5GMM-IDLE mode;
proceed with the pending procedure; and
if the pending procedure is a service request or registration request procedure, the UE may include the Uplink data status IE in the SERVICE REQUEST message, the CONTROL PLANE SERVICE REQUEST message or in the REGISTRATION REQUEST message, indicating the PDU session(s) without active user-plane resources for which the UE has pending user data to be sent, if any, and the PDU session(s) for which user-plane resources were active prior to receiving the fallback indication, if any (see subclauses 5.5.1.3 and 5.6.1 for further details).

If the UE requests the lower layers to transition to RRC_CONNECTED state for other reason than initiation of a registration procedure, or for other reason than a service request procedure, or for other reason than a de-registration procedure, upon fallback indication from lower layers, the UE may:
1) enter 5GMM-IDLE mode;
2) initiate the service request procedure and include the Uplink data status IE in the SERVICE REQUEST message or the CONTROL PLANE SERVICE REQUEST message indicating the PDU session(s) for which user-plane resources were active prior to receiving the fallback indication, if any (see subclause 5.6.1 for further details). If the procedure that triggered the request to the lower layers to transition to RRC_CONNECTED state is the UE-initiated NAS transport procedure and the UE had SMS, location services message, or CIoT user data to send, the UE may also include the SMS, location services message, or CIoT user data in the CONTROL PLANE SERVICE REQUEST message as described in subclause 5.6.1.2.2; and
3) upon successful service request procedure completion, proceed with any pending procedure.

If the UE in 5GMM-CONNECTED mode with RRC inactive indication receives a fallback indication from lower layers, and the UE has pending uplink user data for PDU session(s) with user-plane resources already established but no pending NAS procedure, the UE may:
1) enter 5GMM-IDLE mode; and
2) initiate the service request procedure and include the Uplink data status IE in the SERVICE REQUEST message or the CONTROL PLANE SERVICE REQUEST message indicating the PDU session(s) for which user-plane resources were active prior to receiving the fallback indication (see subclause 5.6.1 for further details).

In the above cases when the UE receives a fallback indication from lower layers, if the UE is in non-allowed area or not in allowed area, the UE may behave as specified in subclause 5.3.5.

If the UE in 5GMM-CONNECTED mode with RRC inactive indication receives an indication from the lower layers that the resumption of the RRC connection has failed, and:
a) if the lower layers indicate that access barring is applicable for all access categories except categories 0 and 2, the UE may:
1) stay in 5GMM-CONNECTED mode with RRC inactive indication;
b) else, the UE may:
1) enter 5GMM-IDLE mode; and
2) initiate the registration procedure for mobility and periodic registration update used for mobility (i.c. the 5GS registration type IE set to “mobility registration updating” in the REGISTRATION REQUEST message) for N1 NAS signalling connection recovery as specified in subclause 5.5.1.3.2.

NOTE 2: An indication from the lower layer that the RRC connection has been released with cause “RRC resume failure” can be considered as an indication that the resumption of the RRC connection has failed.

The UE may transition from 5GMM-CONNECTED mode with RRC inactive indication to 5GMM-IDLE mode over 3GPP access upon receiving from the lower layers:
a) indication of transition from RRC_INACTIVE state to RRC_IDLE state; or
b) indication of cell selection to E-UTRAN or another RAT that the UE supports.

If the UE in 5GMM-CONNECTED mode with RRC inactive indication receives an indication from the lower layers about the cell (re-)selection to different RAT that the UE supports, the UE may initiate the registration procedure for mobility or periodic registration update used for mobility (i.c. the 5GS registration type IE set to “mobility registration updating” in the REGISTRATION REQUEST message) as specified in subclause 5.5.1.3.2.

If the UE in 5GMM-CONNECTED mode with RRC inactive indication receives an indication from the lower layers of a transition from RRC_INACTIVE state to RRC_IDLE state and 5GMM-REGISTERED.LIMITED-SERVICE is entered, the UE may subsequently upon entering state 5GMM-REGISTERED.NORMAL-SERVICE and if there is no uplink user data or signalling pending, initiate the registration procedure for mobility and periodic registration update used for mobility (i.e. the 5GS registration type IE set to “mobility registration updating” in the REGISTRATION REQUEST message) for N1 NAS signalling connection recovery as specified in subclause 5.5.1.3.2.

Upon receiving AMF paging indication from the lower layers, the UE may transition from 5GMM-CONNECTED mode with RRC inactive indication to 5GMM-IDLE mode over 3GPP access and handle the AMF paging same as the paging request received in the 5GMM-IDLE mode over 3GPP access as specified in subclause 5.6.1.”

As can be seen from the above, how the UE transitions to connected mode varies based on the trigger at the NAS. In some cases, the UE would need to first go to 5GMM-IDLE mode and re-establish the connection, while in other cases the UE requests the RRC to resume its connection. In the latter case, the NAS may or may not send a message after the resumption of the RRC connection which again is determined based on the reason to resume the connection.

The UE in 5GMM-CONNECTED mode may receive a fallback indication from the RRC layer after which the UE re-establishes the NAS signaling connection as described in section 5.3.1.2 of TS 24.501.

The following is an excerpt from TS 24.501 on how the NAS connection can be re-established.

“When the UE in 5GMM-CONNECTED mode over 3GPP access receives a fallback indication from lower layers, and the UE has no pending NAS procedure and no pending uplink user data for PDU session(s) with user-plane resources already established, the UE may:
a) enter 5GMM-IDLE mode; and
b) initiate the registration procedure for mobility and periodic registration update and include the Uplink data status IE in the REGISTRATION REQUEST message indicating the PDU session(s) for which user-plane resources were active prior to receiving the fallback indication, if any (see subclause 5.5.1.3 for further details).

When the UE in 5GMM-CONNECTED mode over 3GPP access receives a fallback indication from lower layers, and the UE has pending uplink user data for PDU session(s) with user-plane resources already established but no pending NAS procedure, the UE may:
a) enter 5GMM-IDLE mode; and
b) initiate the service request procedure and include the Uplink data status IE in the SERVICE REQUEST message indicating the PDU session(s) for which user-plane resources were active prior to receiving the fallback indication (see subclause 5.6.1 for further details).

When the UE in 5GMM-CONNECTED mode over 3GPP access receives a fallback indication from lower layers, and the UE has a pending registration procedure, a service request procedure, or a de-registration procedure, the UE may:
a) enter 5GMM-IDLE mode;
b) proceed with the pending procedure; and
c) if the pending procedure is a service request or registration procedure, the UE may include the Uplink data status IE in the SERVICE REQUEST message, or in the REGISTRATION REQUEST message, indicating the PDU session(s) for which user-plane resources were not active prior to receiving a fallback indication from the lower layers and the UE has pending user data to be sent over 3GPP access, if any, and the PDU session(s) for which user-plane resources were active prior to receiving the fallback indication, if any (see subclauses 5.5.1.3 and 5.6.1 for further details).

When the UE in 5GMM-CONNECTED mode over 3GPP access receives a fallback indication from lower layers, and the UE has a pending NAS procedure other than a registration procedure, a service request procedure, or a de-registration procedure, the UE may:
a) enter 5GMM-IDLE mode;
b) initiate the service request procedure and include the Uplink data status IE in the SERVICE REQUEST message indicating the PDU session(s) for which user-plane resources were active prior to receiving the fallback indication, if any (see subclause 5.6.1 for further details); and
c) upon successful service request procedure completion, proceed with any pending procedure.

The cases above apply when the UE is in an allowed area or when the UE is not in a non-allowed area.

When the UE:
a) is in a non-allowed area or is not in an allowed area;
b) is in 5GMM-CONNECTED mode over 3GPP access;
c) receives a fallback indication from lower layers; and
d) does not have signalling pending,

the UE may:
a) enter 5GMM-IDLE mode; and
b) initiate the registration procedure for mobility and periodic registration update.

The UE may not include the Uplink data status IE in the REGISTRATION REQUEST message except if the PDU session for which user-plane resources were active is an emergency PDU session, or if the UE is configured for high priority access in the selected PLMN.

In the above cases when the UE receives a fallback indication from lower layers, if the UE is in non-allowed area or not in allowed area, the UE may behave as specified in subclause 5.3.5.”

As can be seen from the above, depending on a particular type of procedure that may be pending before the fallback indication is received by NAS, the recovery method (i.e. re-establishment of the NAS connection) may vary.

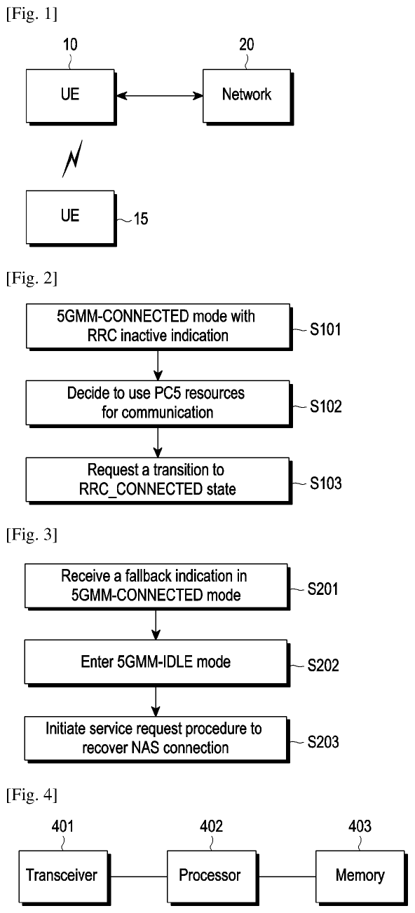

FIG. 1 shows a general representation of a User Equipment 10 in communication with a telecommunication network 20. The element of the network 20 which connects to the UE 10 is typically a base station or gNB.

In an embodiment, a solution may be provided for a UE (e.g., the UE 10) in 5GMM-CONNECTED with RRC inactive indication which requires to transition to 5GMM-CONNECTED mode for the purpose of (e.g. to perform or use) PC5 discovery and/or PC5 communication.

The UE 10 connected to the network 20 (relay UE) may provide network access to another UE 15 (remote UE) by establishing a direct one-to-one connection with it using the sidelink (SL) channels over the PC5 interface. The PC5 signaling protocol, which is used for the establishment and maintenance of the one-to-one direct communication connection between the relay UE (e.g., the UE 10) and the remote UE (e.g., the UE 15), and involves different procedures and timers are described in the 3GPP standard.

There are several options, which are presented in the following.

### Option 1

If the UE (e.g., the UE 10) in 5GMM-CONNECTED with RRC inactive indication wants to use or perform PC5 discovery and/or PC5 communication (or when the UE has to request resources for ProSe direct discovery over PC5 or ProSe direct communication over PC5, or V2X communication over PC5), then the NAS (e.g., the NAS layer of the UE 10) may request the lower layers to transition to RRC_CONNECTED state (or to resume the RRC connection and thereby transition from RRC_INACTIVE state to RRC_CONNECTED state). Note that in this case, the NAS need not send a NAS message and the mere request to the lower layers to transition to RRC_CONNECTED state is sufficient.

When the lower layers indicate that the UE (or RRC) is now in RRC_CONNECTED state, the NAS may then enter 5GMM-CONNECTED mode. Furthermore, the NAS may inform the ProSe layer in the UE (e.g. an upper layer in the UE) that the UE is now in 5GMM-CONNECTED mode and as such PC5 discovery and/or PC5 communication can be performed. Note that the request from the NAS to the lower layers to transition to RRC_CONNECTED state may be triggered by a request from the upper layers (or ProSe layer) to perform PC5 discovery and/or PC5 communication (or by the V2X layer to perform V2X communication over PC5).

### Option 2

If the UE (c.g., the UE 10) in 5GMM-CONNECTED with RRC inactive indication wants to use or perform PC5 discovery and/or PC5 communication (or when the UE has to request resources for ProSe direct discovery over PC5 or ProSe direct communication over PC5, or when the UE has to request resources for V2X communication over PC5), then the NAS (e.g., the NAS layer of the UE 10) may initiate a service request procedure and send a Service Request (or Control Plane Service Request: CPSR) message.

### Option 3

If the UE (e.g., the UE 10) in 5GMM-CONNECTED with RRC inactive indication wants to use or perform PC5 discovery and/or PC5 communication (or when the UE has to request resources for ProSe direct discovery over PC5 or ProSe direct communication over PC5, or when the UE has to request resources for V2X communication over PC5), then the NAS (e.g., the NAS layer of the UE 10) may initiate a registration for mobility and periodic registration update by sending a REGISTRATION REQUEST message.

For any of the three options above, if the UE also requires to request the establishment of user-plane resources for at least one PDU session, then the UE may also include the Uplink data status IE in the NAS message (e.g., the CPSR message or the REGISTRATION REQUEST message). The UE may set the IE such that the PDU session (identified by a PDU session ID) has the corresponding bit set to 1, thereby indicating that user-plane resources are being requested for the identified PDU session.

The following also applies when the UE in 5GMM-CONNECTED with RRC inactive indication receives a fallback indication and the UE wants to perform PC5 discovery and/or PC5 communication.

When the UE in 5GMM-CONNECTED mode with RRC inactive indication receives a fallback indication from lower layers, and the UE has no pending NAS procedure and no pending uplink user data for PDU session(s) with user-plane resources already established, and the UE needs to request resources for ProSe direct discovery over PC5 or ProSe direct communication over PC5 (or when the UE has to request resources for V2X communication over PC5), the UE may:
a) enter 5GMM-IDLE mode; and
b) initiate the registration procedure for mobility and periodic registration update and include the Uplink data status IE in the REGISTRATION REQUEST message indicating the PDU session(s) for which user-plane resources were active prior to receiving the fallback indication, if any (see subclause 5.5.1.3 for further details).

Alternatively, when the UE in 5GMM-CONNECTED mode with RRC inactive indication receives a fallback indication from lower layers, and the UE has no pending NAS procedure and no pending uplink user data for PDU session(s) with user-plane resources already established, and the UE needs to request resources for ProSe direct discovery over PC5 or ProSe direct communication over PC5 (or when the UE has to request resources for V2X communication over PC5), the UE may:
a) enter 5GMM-IDLE mode; and
b) initiate the service request procedure and include the Uplink data status IE in the Service Request (or CPSR) message indicating the PDU session(s) for which user-plane resources were active prior to receiving the fallback indication, if any.

Note that for any of the cases in which the UE sends a Service Request message (or CPSR message), either to transition from 5GMM-IDLE mode to 5GMM-CONNECTED mode or from 5GMM-CONNECTED mode with RRC inactive to 5GMM-CONNECTED mode, for the purpose of requesting resources for ProSe direct discovery over PC5 or ProSe direct communication over PC5 (or when the UE has to request resources for V2X communication over PC5), then the UE may take the following actions:
The Service type IE in the Service Request message (or the Control plane service type IE in the CPSR message) may be set to:
a new value, where the value may indicate e.g. “PC5 discovery”, or “PC5 communication”, or “PC5 discovery and/or communication”, where the value may be determined by the UE based on the type of PC5 procedure that needs to be performed, or based on a pre-defined value; or
“high priority access”, if the UE is configured as high priority access; or
otherwise, the Service type IE in the SERVICE REQUEST message (or the Control plane service type IE in the CPSR message) is set to “signalling”, except if there is a an emergency PDU session which is indicated in the Uplink data status IE the service type IE in the SERVICE REQUEST message may be set to “emergency services”
When sending (e.g. before sending) the Service Request message (or the CPSR message), if the UE has pending uplink user data to send for a PDU session, then the UE may also include the Uplink data status IE in the SERVICE REQUEST message (or CPSR message) to indicate which PDU session(s) associated with the access type the SERVICE REQUEST message (or CPSR message) is sent over have pending user data to be sent.

Note that all of the above applies in the case of V2X services for which the UE may also require user plane resources for PC5 communication. As such, all the references to “ProSe (direct) discovery over PC5 or ProSe (direct) communication over PC5” (or similar terms) can be replaced by “V2X communication over PC5”. As such the embodiments described herein apply equally to V2X communication over PC5.

FIG. 2 shows a flowchart setting out certain steps described above.

Referring to FIG. 2, at Step S101, the UE 10 may be in 5GMM-CONNECTED mode with RRC inactive indication. At step S102, the UE may decide to use PC5 resources for communication. At step S103, UE may request a transition to RRC_CONNECTED state.

The following embodiments relate more specifically to the second problem identified earlier, namely that associated with how to achieve recovery from a lower layer fallback indication for the purpose of PC5 discovery and/or communication.

A UE in 5GMM-CONNECTED mode may receive a fallback indication from the lower layers and hence the UE will need to re-establish its NAS signalling connection. When this occurs for a UE that was using resources for PC5 discovery and/or communication (or V2X communication over PC5), then the UE may re-establish its NAS connection by either performing a registration procedure or a service request procedure as is explained below.

When the UE in 5GMM-CONNECTED mode over 3GPP access receives a fallback indication from lower layers, and:
a) the UE has no pending NAS procedure and no pending uplink user data for PDU session(s) with user-plane resources already established, or
b) the UE was using (PC5) resources for ProSe PC5 discovery or ProSe PC5 communication (i.e. the UE was performing PC5 discovery and/or PC5 communication), or the UE was using (PC5) resources for V2X communication over PC5;

the UE may:
a) enter 5GMM-IDLE mode; and
b) initiate the registration procedure for mobility and periodic registration update and include the Uplink data status IE in the REGISTRATION REQUEST message in- dicating the PDU session(s) for which user-plane resources were active prior to receiving the fallback indication, if any (see subclause 5.5.1.3 for further details).

Alternatively, when the UE in 5GMM-CONNECTED mode over 3GPP access receives a fallback indication from lower layers, and:
a) the UE has no pending NAS procedure and no pending uplink user data for PDU session(s) with user-plane resources already established, or
b) the UE was using (PC5) resources for ProSe PC5 discovery or ProSe PC5 communication (i.e. the UE was performing PC5 discovery and/or PC5 communication), or the UE was using (PC5) resources for V2X communication over PC5;

the UE may:
a) enter 5GMM-IDLE mode; and
b) initiate the service request procedure and include the Uplink data status IE in the SERVICE REQUEST message (or CPSR message) indicating the PDU session(s) for which user-plane resources were active prior to receiving the fallback indication, if any (see subclause 5.5.1.3 for further details).

Based on the above, embodiments of the disclosure provide that a UE in 5GMM-CONNECTED mode that receives a fallback indication from the lower layers may re-establish the NAS signalling connection by sending either a Registration Request message or a Service Request message after first entering 5GMM-IDLE mode. This applies if the UE was using PC5 resources for, or performing, PC5 discovery and/or PC5 communication (either for ProSe or V2X) before the fallback indication was received. Optionally, the UE behaves as explained if the UE has no other pending NAS procedure.

FIG. 3 shows a flowchart setting out certain steps described above.

Referring to FIG. 3, at S201, the UE 10 may be in 5GMM-CONNECTED mode and receive a fallback indication. The UE may have no ongoing NAS procedure and no pending uplink user data for a Protocol Data Unit, PDU, session. The UE 10 may be using network resources for 5G ProSe direct discovery or 5G ProSe direct communication. At S202, the UE 10 may enter 5GMM-IDLE mode. At S203, the UE 10 may initiate a service request procedure to recover the NAS connection.

By means of embodiments of the disclosure, a UE 10 may be configured to behave in a consistent and defined manner in the circumstances illustrated. This overcomes the problems identified with the prior art, whereby the UE could act in an unpredictable manner, resulting in errors or malfunctions.

FIG. 4 shows a block diagram illustrating a structure of a user equipment according to an embodiment of the disclosure.

Referring to FIG. 4, the UE 10 includes a transceiver 401, a processor 402, and a memory 403. The transceiver 401 may be configured to transmit and receive signals to and from the outside. The processor 402 may be configured to perform any of the above embodiments performed by the UE 10. The memory 403 may store program codes and data for operating the processor 402. The UE 10 may be implemented in a form of hardware, software or a combination of hardware and software, so that it may perform the above methods performed by the user equipment described in the disclosure.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of operating a User Equipment, UE, operable to communicate with a telecommunication network, the method comprising:
identifying, by the UE, that the UE is in 5GMM-CONNECTED mode with a radio resource control, RRC, inactive indication and the UE wishes to use PC5 resources for PC5 communication; and
in response to the identifying, transitioning to RRC_CONNECTED state.

2. The method of claim 1, wherein the PC5 resources are for one or more of: 5G ProSe direct discovery over PC5; 5G ProSe direct communication over PC5; or V2X communication over PC5.

3. The method of claim 1, further comprising:
requesting, by a non-access stratum, NAS, layer of the UE to a lower layer of the UE, to transition to the RRC_CONNECTED state.

4. The method of claim 3, wherein, when the lower layer indicates the UE is in the RRC CONNECTED state, the NAS layer enters 5GMM-CONNECTED mode and informs the ProSe layer that the UE is in 5GMM-CONNECTED mode and the PC5 communication can be performed.

5. The method of claim 4, wherein the request from the NAS layer to the lower layer to transition to the RRC_CONNECTED sate is triggered by a request from a ProSe layer of the UE to perform the PC5 communication.

6. A UE operable to communicate with a telecommunication network, the UE comprising:
a transceiver; and
a processor coupled with the transceiver,
wherein the processor is configured to:
identify that the UE is in 5GMM-CONNECTED mode with a radio resource control, RRC, inactive indication and the UE wishes to use PC5 resources for PC5 communication, and in response to the identifying, transition to RRC_CONNECTED state.

7. The UE of claim 6, wherein the PC5 resources are for one or more of: 5G ProSe direct discovery over PC5; 5G ProSe direct communication over PC5; or V2X communication over PC5.

8. The UE of claim 6, wherein the processor comprises a lower layer, a non-access stratum, NAS, layer, and a ProSe layer, and
wherein the NAS layer requests the lower layer to transition to the RRC_CONNECTED state.

9. The UE of claim 8, wherein, when the lower layer indicates the UE is in the RRC_CONNECTED state, the NAS layer enters 5GMM-CONNECTED mode and informs the ProSe layer that the UE is in 5GMM-CONNECTED mode and the PC5 communication can be performed.

10. The UE of claim 9, wherein the request from the NAS layer to the lower layer to transition to the RRC_CONNECTED sate is triggered by a request from the ProSe layer of the UE to perform the PC5 communication.

11. A method of operating a User Equipment, UE, operable to communicate with a telecommunication network, the method comprising:
identifying that the UE, in 5GMM-CONNECTED mode, receives a fallback indication, the UE has no ongoing non-access stratum, NAS, procedure and no pending uplink user data for a Protocol Data Unit, PDU, session, and the UE, at the time of receiving the fallback indication, was using network resources for 5G ProSe direct discovery, 5G ProSe direct communication or V2X communication over PC5; and
in response to the identifying, entering 5GMM-IDLE mode and initiates a service request procedure to recover a NAS connection.

12. The method of claim 11, wherein, while recovering the NAS connection, the UE includes an Uplink data stats Information Element, IE, in a Service Request message or Control Plane Service Request message, indicating the PDU session for which User Plane, UP, resources were active prior to receipt of the fallback indication.

13. The method of claim 11, wherein, while recovering the NAS connection, the UE includes an Uplink data stats Information Element, IE, in a Service Request message or Control Plane Service Request message, indicating the PDU session for which User Plane, UP, resources were active prior to receipt of the fallback indication.

14. A UE operable to communicate with a telecommunication network, the UE comprising:
a transceiver; and
a processor coupled with the transceiver,
wherein the processor is configured to:
identify that the UE, in 5GMM-CONNECTED mode, receives a fallback indication, the UE has no ongoing non-access stratum, NAS, procedure and no pending uplink user data for a Protocol Data Unit, PDU, session, and the UE, at the time of receiving the fallback indication, was using network resources for 5G ProSe direct discovery, 5G ProSe direct communication or V2X communication over PC5, and
in response to the identifying, entering 5GMM-IDLE mode and initiates a service request procedure to recover a NAS connection.

15. The UE of claim 14, wherein, while recovering the NAS connection, the processor includes an Uplink data stats Information Element, IE, in a Service Request message or Control Plane Service Request message, indicating the PDU session for which User Plane, UP, resources were active prior to receipt of the fallback indication.

16. The UE of claim 14, wherein, while recovering the NAS connection, the processor includes an Uplink data stats Information Element, IE, in a Service Request message or Control Plane Service Request message, indicating the PDU session for which User Plane, UP, resources were active prior to receipt of the fallback indication.

17. The method of claim 1, further comprising:
identifying that the UE, in 5GMM-CONNECTED mode, receives a fallback indication, the UE has no ongoing non-access stratum, NAS, procedure and no pending uplink user data for a Protocol Data Unit, PDU, session, and the UE, at the time of receiving the fallback indication, was using network resources for 5G ProSe direct discovery, 5G ProSe direct communication or V2X communication over PC5; and
in response to the identifying, entering 5GMM-IDLE mode and initiates a service request procedure to recover a NAS connection.

18. The method of claim 17, wherein, while recovering the NAS connection, the UE includes an Uplink data stats Information Element, IE, in a Service Request message or Control Plane Service Request message, indicating the PDU session for which User Plane, UP, resources were active prior to receipt of the fallback indication.

19. The UE of claim 6, wherein the processor is further configured to:
identify that the UE, in 5GMM-CONNECTED mode, receives a fallback indication, the UE has no ongoing non-access stratum, NAS, procedure and no pending uplink user data for a Protocol Data Unit, PDU, session, and the UE, at the time of receiving the fallback indication, was using network resources for 5G ProSe direct discovery, 5G ProSe direct communication or V2X communication over PC5, and
in response to the identifying, entering 5GMM-IDLE mode and initiates a service request procedure to recover a NAS connection.

20. The UE of claim 19, wherein, while recovering the NAS connection, the processor includes an Uplink data stats Information Element, IE, in a Service Request message or Control Plane Service Request message, indicating the PDU session for which User Plane, UP, resources were active prior to receipt of the fallback indication.
